(19) United States
(12) Patent Application Publication
(10) Pub. No.: US 2012/0144197 A1
(43) Pub. Date: Jun. 7, 2012

(54) POINT-TO-POINT COMMUNICATION METHOD IN A WIRELESS SENSOR NETWORK AND METHODS OF DRIVING COORDINATORS AND COMMUNICATION DEVICES IN THE WIRELESS SENSOR NETWORK

(76) Inventors: Jong-Moon Chung, Seoul (KR); Hyun-Jue Kim, Seoul (KR)

(21) Appl. No.: 12/958,485

(22) Filed: Dec. 2, 2010

(51) Int. Cl. H04L 9/00

(52) U.S. Cl. 713/169; 380/44

(57) ABSTRACT

The present invention relates to a point-to-point communication method that performs mutual authentication and creates link keys without using a master key. The point-to-point communication method can include authentication by exchanging authentication information between a first node and a second node from among the plural nodes; and having each of the first node and the second node create a link key, after the authentication is completed. During the authentication, the authentication information uses a secret key of a corresponding coordinator (node).

### TECHNICAL FIELD

The present invention relates to a point-to-point communication method in a wireless sensor network and methods of driving coordinators and communication devices in the wireless sensor network, and more particularly to a point-to-point communication method which performs mutual authentication and creates link keys, using only the secret keys of the coordinators, without using a master key.

### BACKGROUND ART

A wireless sensor network generally has the structure illustrated in FIG. 1 below.

FIG. 1 is a drawing illustrating a general wireless sensor network.

With reference to FIG. 1, a wireless sensor network consists of multiple clusters 100, etc., and each cluster includes multiple nodes, such as coordinators 102 and communication devices 104.

Below, a conventional point-to-point communication method in such a wireless sensor network will be described.

First, the communication process between a coordinator and a communication device within the same cluster will be explained.

FIG. 2 is a flowchart illustrating a conventional communication process between the coordinator and a communication device within the same cluster. However, for the sake of ease of explanation, the coordinator and communication device are assumed to be the coordinator 102 and the communication device 104 within the cluster 100.

The communication device 104 requests the coordinator 102 for the transmission of a master key, which is a secret key, and the coordinator 102, in response to the request, transmits to the communication device 104 the corresponding master key (operation S202).

Next, the coordinator 102 and the communication device 104, by using the master key, perform symmetric-key key establishment (SKKE) protocols (operations S204, S206, S208 and S210), thereby generating link keys (operations S212 and S214).

Below, the communication process between communication devices within the same cluster will be explained.

FIG. 3 is a flowchart illustrating the communication process between communication devices within the same cluster. However, for the sake of ease of explanation, the coordinator and communication devices are assumed to be the coordinator 102 and the communication devices 104a and 104b within the cluster 100.

When a first communication device 104a requests the coordinator 102 for the transmission of the master key (operation S300), the coordinator 102, in response to the request, transmits to the communication devices 104a and 104b the corresponding master keys (operations S302 and S304).

Next, the communication devices 104a and 104b, by using the master key, perform symmetric-key key establishment (SKKE) protocols (operations S306, S308, S310 and S312), thereby generating link keys (operations S314 and S316).

Such a point-to-point communication method in a wireless sensor network may have various problems.

First, not only does the coordinator have to have as many master keys and link keys as the corresponding communication devices, but also it has to have all the master keys that are used between the communication devices, and therefore, managing the keys is difficult. Consequently, application can be impossible with a network model that includes multiple clusters having many nodes.

Also, in the process of transmitting the master key, since a secure channel for the transmission of the master key is not obtained, the master key may be exposed to the outside. If the master key is thus exposed, anyone can use the master key to create link keys, irrespective of the safety of subsequent communications to be performed. Consequently, the security of the network can be compromised.

In addition, since the coordinator performs the transmission of the master key and other tasks even in the communication between communication devices that are not related to the coordinator, the load can become concentrated on the coordinator. Thus, the action of the coordinator can slow down, resulting in the lengthening of the communication time; in other words, the performance of the network can be decreased.

### DISCLOSURE

### Technical Problem

A purpose of the present invention is to offer a point-to-point communication method in a wireless sensor network and methods of driving coordinators and communication devices in the wireless sensor network, methods that can improve the performance of the network while maintaining security in a stable manner.

### Technical Solution

In order to accomplish the aforementioned purpose, an aspect of the present invention provides a point-to-point communication method in a wireless sensor network having plural nodes. This method includes: authentication by exchanging authentication information between a first node and a second node from among the plural nodes; and having each of the first node and the second node create a link key, after the authentication is completed. During the authentication, the authentication information uses a secret key of a corresponding coordinator (node).

Another aspect of the present invention provides a method of driving a coordinator included in a wireless sensor network, where the method includes: creating a first public key by using a first secret key of the coordinator; and creating a second secret key for at least one communication device in the same cluster, by using the first secret key.

Yet another aspect of the present invention provides a method of driving a first communication device included in a wireless sensor network. The method may include: transmitting a first authentication information and a first link key creation information to a coordinator or a second communication device; authenticating a coordinator or a second communication device through a second authentication information transmitted from the coordinator or the second communication device; and creating a link key by using a second link key creation information transmitted from the coordinator or the second communication device. Here, the authentication information is expressed as a message authentication code (MAC) and uses a pairing function, and the link key is expressed as a hash function.

### Advantageous Effects

A point-to-point communication method in a wireless sensor network according to an embodiment of the present invention can be applied to multiple clusters that include many nodes, and thus it is applicable to a realistic network model formed by multiple clusters.

Also, a point-to-point communication method according to an embodiment of the present invention has the advantage of being able to maintain security in a stable manner, as it does not use a master key.

In addition, a point-to-point communication method according to an embodiment of the present invention has the advantage of allowing a simplified mode of key management, since it is sufficient for each coordinator to manage its own secret key only.

Furthermore, in a point-to-point communication method according to an embodiment of the present invention, since the coordinator is not involved in the authentication between communication devices, the load is not concentrated on the coordinator, and thus the network speed can be enhanced; in other words, it has the advantage of enhancing the performance of the network.

Also, the point-to-point communication method according to an embodiment of the present invention has the advantage of preventing replay attacks, since link key creation information is created along with time information.

### DESCRIPTION OF DRAWINGS

FIG. 1 is a drawing illustrating a general wireless sensor network.

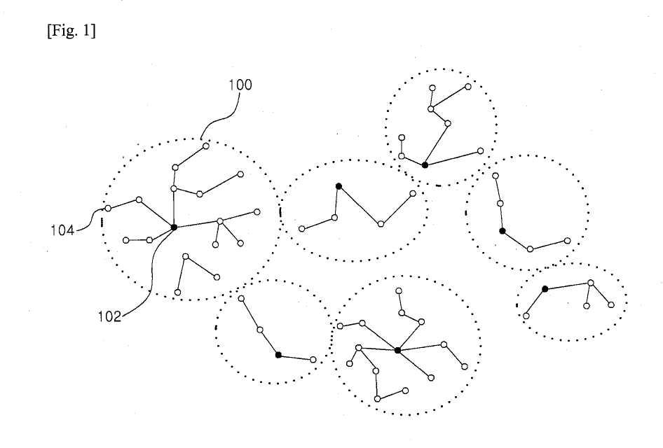

FIG. 2 is a flowchart illustrating a communication process between a coordinator and a communication device within the same cluster according to the related art.

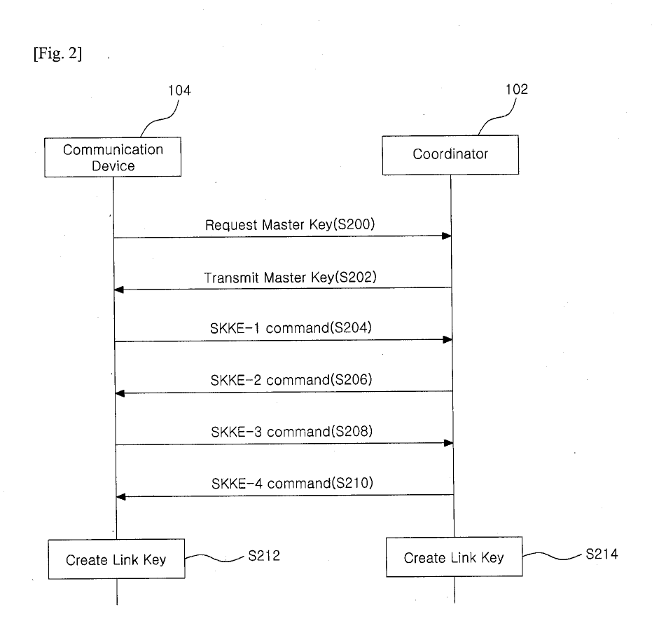

FIG. 3 is a flowchart illustrating a communication process between communication devices within the same cluster according to the related art.

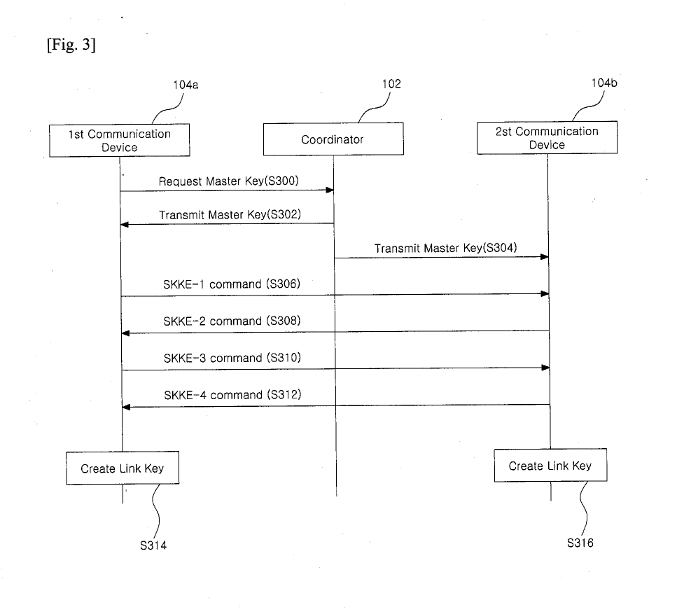

FIG. 4 is a drawing illustrating the configuration of a wireless sensor network according to an embodiment of the present invention.

FIG. 5 is a flowchart illustrating a point-to-point communication method in a wireless sensor network according to an embodiment of the present invention.

FIG. 6 is a flowchart illustrating a communication process between a coordinator and a communication device within the same cluster according to an embodiment of the present invention.

FIG. 7 is a flowchart illustrating a communication process between communication devices within the same cluster according to an embodiment of the present invention.

FIG. 8 is a flowchart illustrating a communication process between coordinators in different clusters according to an embodiment of the present invention.

FIG. 9 is a flowchart illustrating a communication process between a coordinator in a first cluster and a communication device in a second cluster according to an embodiment of the present invention.

FIG. 10 is a flowchart illustrating the communication process between communication devices in different clusters according to an embodiment of the present invention.

### DETAILED DESCRIPTIONS

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. Those components that are the same or are in correspondence are rendered the same reference numeral regardless of the figure number.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, phases, actions, components, parts, or combinations thereof disclosed in the specification, and are not intended to preclude the possibility that one or more other features, numbers, steps, actions, components, parts, or combinations thereof may exist or may be added.

Unless otherwise defined, all terms used herein, including technological or scientific terms, have the same meanings as generally understood by those skilled in the technological field to which the present invention belongs. The terms that find other definitions in generally used dictionaries are to be interpreted as having meanings that harmonize with the related technological context, and unless otherwise clearly defined in the present patent application, are not to be interpreted as having idealistic or excessively formalistic meanings.

Below, certain embodiments of the present invention will be explained in detail with reference to the accompanying drawings.

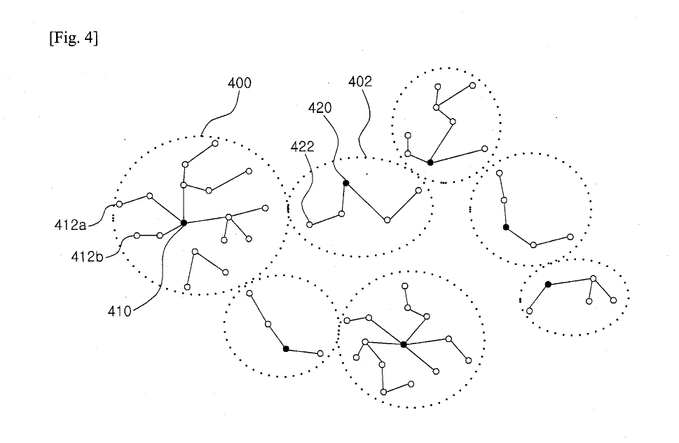

FIG. 4 is a drawing illustrating the configuration of a wireless sensor network according to an embodiment of the present invention.

With reference to FIG. 4, a wireless sensor network according to this embodiment includes plural clusters, 400, 402, etc.

According to an embodiment of the present invention, the wireless sensor network can use ZigBee but is not limited to ZigBee, and various communication methods can be used.

Each cluster 400, 402, etc., has nodes, such as a coordinator and at least one communication device. For example, a cluster 400 can include one coordinator 410 and plural communication devices 412a, 412b, etc.

The coordinator performs the role of a trusted third party, distributing keys for encryption for the sake of network security, managing the keys, etc., and uses its own secret key to create and to manage a public key, as well as secret keys for communication devices within the same cluster.

Also, the coordinator authenticates a counterpart node through the authentication information transmitted from the counterpart node, and after authentication is completed, uses link key creation information transmitted from the counterpart node to create a link key.

A communication device is provided with its secret key by a corresponding coordinator, and uses its secret key, etc., to create authentication information and link key creation information.

Also, the communication device authenticates a counterpart node through the authentication information transmitted from the counterpart node, and after authentication is completed, uses the link key creation information transmitted from the counterpart node to create a link key.

In other words, unlike the conventional technology that uses a master key, a wireless sensor network according to this embodiment, rather than using a master key, instead uses authentication information and link key creation information to create a corresponding link key, and uses the created link key to perform point-to-point communication. A detailed explanation of this will be given later.

Below, a point-to-point communication method in a wireless sensor network according to an embodiment of the present invention will be described with reference to the appended illustrations.

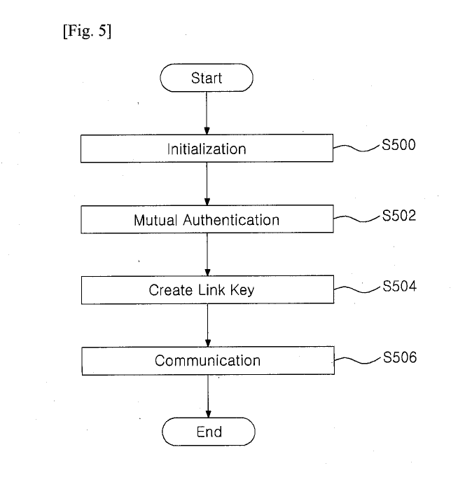

FIG. 5 is a flowchart illustrating the point-to-point communication method in a wireless sensor network according to an embodiment of the present invention. Here, it shall be assumed that the number of clusters in the wireless sensor network is n (an integer equal to or greater than 2).

With reference to FIG. 5, each of the clusters Cᵢ performs an initialization process (operation S500), where 1 [symbol] [symbol] .

In more detail, each coordinator Cᵢ selects its first secret key sᵢ from a particular group Zₚ*, where sᵢ∈Zₚ*, and uses the first secret key selected above to create a public key P_{pubi} as in Formula 1 below. Also, each coordinator Cᵢ uses the first secret key sᵢ to create second secret keys S₍ᵢ₎ⱼ as in Formula 2 below for the communication devices D₍ᵢ₎ⱼ within the same cluster.

P_{pubi}=sᵢP [Formula 1]

Here, P is the source of G₁, and G₁ represents an additive group having a prime number p as its order.

S₍ᵢ₎ⱼ=sᵢQ₍ᵢ₎ⱼ

Q₍ᵢ₎ⱼ=H₁(ID₍ᵢ₎ⱼ)∈G₁, 1 [symbol] [symbol] [Formula 2]

Here, Q₍ᵢ₎ⱼ represents the public key of the “j”th communication device out of the communication devices belonging to the “i”th cluster, S₍ᵢ₎ⱼ represents the secret key of the communication device, and ID₍ᵢ₎ⱼ represents the identification information of the communication device.

Each of the coordinators Cᵢ, as can be seen in Formula 2 above, uses its first secret key sᵢ to create the second secret keys S₍ᵢ₎ⱼ for the communication devices within the same cluster, and saves the second keys S₍ᵢ₎ⱼ in the corresponding communication devices. In other words, in an embodiment of the present invention, the coordinators only manage their own first secret keys sᵢ, and do not use master keys which can be exposed to the outside.

With reference to the public key Q₍ᵢ₎ⱼ of a communication device, the public key, as indicated in Formula 2, is expressed as a hash function H₁, a computation method which creates a pseudo random number of a fixed length in a given text, and which is a value that anyone can compute from the known identification information ID₍ᵢ₎ⱼ. In other words, the public key Q₍ᵢ₎ⱼ is information accessible to anyone.

Next, nodes performing point-to-point communication each create authentication information, exchange the authentication information, and authenticate their counterparts through the authentication information transmitted from them (operation S502).

Subsequently, nodes performing point-to-point communication each create link key creation information, exchange the link key creation information, and create link keys through the link key creation information transmitted from their counterparts (operation S504).

Next, the nodes each use the created link keys to communicate mutually (operation S506).

In short, in the wireless sensor network of the present embodiment, nodes performing point-to-point communication first authenticate each other, and after authentication is completed, respectively create link keys. Consequently, the wireless sensor network can perform stable communication.

Below, the authentication process between nodes performing point-to-point communication and the link key creation process will be described with reference to the appended illustrations. However, communication between nodes can be divided into the following categories: communication between the coordinator and a communication device within the same cluster; communication between communication devices within the same cluster; communication between coordinators of different clusters; communication between the coordinator of one cluster and a communication device of another cluster; and communication between a communication device of one cluster and that of another cluster.

Below, the authentication process and the link key creation process for each category will be explained.

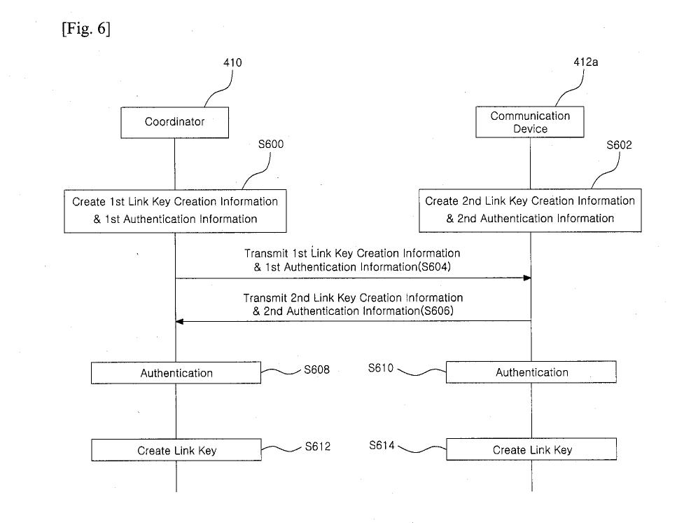

FIG. 6 is a flowchart illustrating the communication process between a coordinator and a communication device within the same cluster according to an embodiment of the present invention. However, for the sake of ease of explanation, it is assumed that communication is made between the coordinator 410, Cᵢ, within the “i”th cluster 400 and the “j”th communication device 412a, D₍ᵢ₎ⱼ, out of the communication devices within the cluster 400 in FIG. 4.

With reference to FIG. 6, the coordinator 410, as in Formula 3 below, uses its first secret key sᵢ to create a first link key creation information R_{c(i)j} and a first authentication information M_{c(i)j} (operation S600).

$${R}_{{c}_{( i ) j}} = {r}_{{c}_{( i ) j}} P \\ {M}_{c ( i ) j} = {MAC}_{{F}_{C , {D}_{( i ) j}}} ( {C}_{i} , {D}_{( i ) j} , {R}_{{c}_{( i ) j}} , t ) \qquad [ Formula 3 ]$$

Here, r_{c(i)j} is a random number (integer) selected from a particular group Zₚ*, that is to say, r_{c(i)j}∈Zₚ*, and t is time information.

With reference to Formula 3 above, the coordinator 410 uses a random number r_{c(i)j} in order to create the first link key creation information R_{c(i)j}, and uses a message authentication code, or MAC, having F_{CiD(i)j} as its key, in order to create the first authentication information M_{c(i)j}.

According to an embodiment of the present invention, F_{CiD(i)j} is as in Formula 4 below.

F_{C}_{ᵢ}_{D}_{₍ᵢ₎ⱼ}=e (P, Q₍ᵢ₎ⱼ)^{s}^{ᵢ}² [Formula 4]

In other words, the coordinator 410 uses its first secret key sᵢ and the public key Q₍ᵢ₎ⱼ of the communication device 412a to express the first authentication information M_{c(i)j} as a pairing function (one that satisfies e:G₁×G₁→G₂, e(aP, bQ)=e(P, Q)^{ab}).

With reference to the first authentication information M_{C(i)j} above, the first authentication information M_{C(i)j} can use the time information t. This is in order to prevent replay attacks.

Next, the communication device 412a, as in Formula 5 below, creates a second link key creation information and a second authentication information (operation S602).

$${R}_{{d}_{( i ) j}} = {r}_{{d}_{( i ) j}} p \\ {M}_{d ( i ) j} = {MAC}_{{F}_{C , {D}_{( i ) j}}} ( {C}_{i} , {D}_{( i ) j} , {R}_{{d}_{( i ) j}} , t ) \qquad [ Formula 5 ]$$

Here, r_{d(i)j} is a random number (integer) selected from a particular group Zₚ*, that is to say, r_{d(i)j}∈Zₚ*, and t is time information.

With reference to Formula 5 above, the communication device 412a uses a random number r_{d(i)j} in order to create the second link key creation information R_{d(i)}, and uses a message authentication code (MAC) having F_{CiD(i)j} as its key, in order to create the second authentication information M_{d(i)j}.

According to an embodiment of the present invention, F_{CiD(i)j} is as in Formula 6 below.

F_{C}_{ᵢ}_{D}_{₍ᵢ₎ⱼ}=e(P_{pubi}, S₍ᵢ₎ⱼ)=e(sᵢP, sᵢ Q₍ᵢ₎ⱼ)=(P, Q₍ᵢ₎ⱼ)^{s}^{ᵢ}² [Formula 6]

In other words, the communication device 412a uses the public key P_{pubi} of the coordinator 410 and its own second secret key S₍ᵢ₎ⱼ to express the key F_{CiD(i)j} used in the second authentication information M_{d(i)j} as a pairing function.

With reference to the second authentication information M_{d(i)j} above, the second authentication information M_{d(i)j} can use the time information t for preventing replay attacks.

Subsequently, the coordinator 410 transmits the first link key creation information R_{c(i)j} and the first authentication information M_{c(i)j} to the communication device 412a (operation S604).

Next, the communication device 412a transmits the second link key creation information R_{d(i)j} and the second authentication information M_{d(i)j} to the coordinator 410 (operation S606).

In the transmission process above, the point-to-point communication method in the present embodiment does not transmit a master key, but rather, uses the first secret key sᵢ and the second secret key Sᵢ₍ⱼ₎ to create F_{CiD(i)j}. Consequently, the coordinator 410 and the communication device 412a can create the same key F_{CiD(i)j}, and use the created key F_{CiD(i)j} to authenticate each other. In this case, since the first secret key sᵢ is information known only to the coordinator 410, and the second secret key S₍ᵢ₎ⱼ is the secret key of the communication device 412a, the key F_{CiD(i)j} is secret information that only the coordinator 410 and the communication device 412a can create. Consequently, security can be maintained in a stable manner.

In the case where the information M_{c(i)j} and M_{d(i)j} from the coordinator 410 is used, since the first secret key is information known only to the coordinator 410, even if the information M_{c(i)j} and M_{d(i)j} is exposed to the outside, security can be maintained in a stable manner.

Subsequently, the coordinator 410 authenticates the communication device 412a through the second authentication information M_{d(i)j} transmitted above (operation S608). In more detail, the coordinator 410 uses the key F_{CiD(i)j} of the message authentication code (MAC) to interpret the second authentication information M_{d(i)j}, verifying whether or not the node that transmitted the second authentication information M_{d(i)j} is the communication device 412a. For example, the coordinator 410 may authenticate the communication device 412a as a valid node if the resultant value of the message authentication code (MAC) using the key F_{CiD(i)j} with inputs Cᵢ, D₍ᵢ₎ⱼ, R_{d(i)j}, and t is equal to the value of M_{d(i)j} in Formula 5.

Subsequently, the communication device 412a authenticates the coordinator 410 through the first authentication information M_{c(i)j} transmitted above. In more detail, the communication device 412a uses the key F_{CiD(i)j} of the message authentication code (MAC) to interpret the first authentication information M_{c(i)j}, verifying whether or not the node that transmitted the first authentication information M_{c(i)j} is the coordinator 410. For example, the communication device 412a may authenticate the coordinator 410 as a valid node if the resultant value of the message authentication code (MAC) using the key F_{CiD(i)j} with inputs Cᵢ, D₍ᵢ₎ⱼ, R_{d(i)j}, and t is equal to the value of M_{d(i)j} in Formula 5.

In other words, the point-to-point communication method performs a mutual authentication process between nodes, one authenticating the other as a valid node if the value of the authentication information transmitted from the other is equal to the resultant value of the message authentication code (MAC) that one created for the information transmitted by the other.

Subsequently, the coordinator 410, after mutual authentication is completed, uses the second link key creation information R_{d(i)j} transmitted above to create the link key LK_{CiD(i)j} as in Formula 7 below (operation S612).

LK_{C}_{ᵢ}_{D}_{₍ᵢ₎ⱼ}=H₂(r_{c}_{₍ᵢ₎ⱼ} R_{d}_{₍ᵢ₎ⱼ})=H₂(r_{c}_{₍ᵢ₎ⱼ} r_{d}_{₍ᵢ₎ⱼ} P) [Formula 7]

In other words, the coordinator 410 expresses its random number r_{c(i)j} and the second link key creation information R_{d(i)j} as a hash function, creating the link key LK_{CiD(i)j}.

Subsequently, the coordinator 412a, after mutual authentication is completed, uses the first link key creation information R_{c(i)j} transmitted above to create the link key LK_{CiD(i)j} as in Formula 8 below (operation S614).

LK_{C}_{ᵢ}_{D}_{₍ᵢ₎ⱼ}=H₂(r_{d}_{₍ᵢ₎ⱼ} R_{c}_{₍ᵢ₎ⱼ})=H₂(r_{c}_{₍ᵢ₎ⱼ} r_{d}_{₍ᵢ₎ⱼ} P) [Formula 8]

In other words, the communication device 412a expresses its random number r_{d(i)j} and the first link key creation information R_{c(i)j} as a hash function, creating the link key LK_{CiD(i)j}.

Consequently, the coordinator 410 and the communication device 412a can create the same link key LK_{CiD(i)j}, and use the link key LK_{CiD(i)j} thus created to communicate with each other.

In short, the coordinator and a communication device within the same cluster, for point-to-point communication, first authenticate each other, and if authentication is completed, create the link key.

Next, the communication process (authentication process and link key creation process) between communication devices within the same cluster will be described.

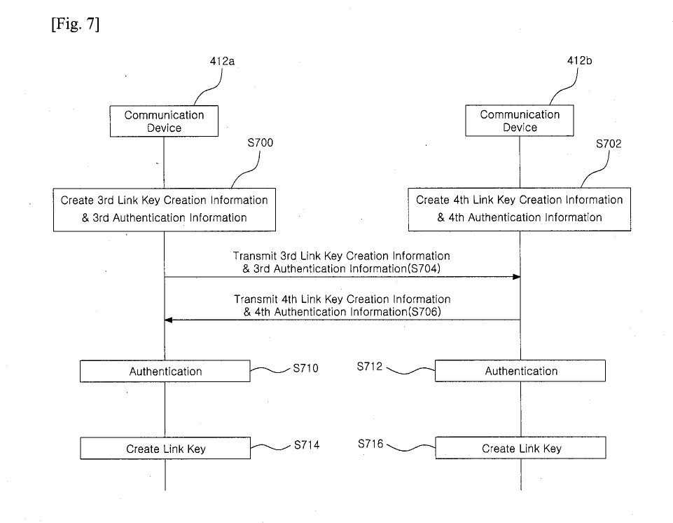

FIG. 7 is a flowchart illustrating the communication process between communication devices within the same cluster, according to an embodiment of the present invention. However, for the sake of ease of explanation, it is assumed that communication is made between the “j”th communication device 412a, D₍ᵢ₎ⱼ, and the “k(1 [symbol] [symbol] )”th communication device 412b, D₍ᵢ₎ₖ, out of the communication devices within the cluster 400 in FIG. 4.

With reference to FIG. 7, the first communication device 412a creates a third link key creation information R_{d(i)jk} and a third authentication information M_{d(i)jk}, as in Formula 9 (operation S700).

$${R}_{d ( i ) jk} = {r}_{d ( i ) jk} P \\ {M}_{d ( i ) jk} = {MAC}_{{F}_{{D}_{( i ) j} {D}_{( i ) k}}} ( {D}_{( i ) j} , {D}_{( i ) k} , {R}_{{d}_{( i ) jk}} , t ) \qquad [ Formula 9 ]$$

Here, r_{d(i)jk} is a random number (integer) selected from a particular group Zₚ*, that is to say, r_{d(i)jk}∈Zₚ*, and t is time information.

With reference to Formula 9 above, the first communication device 412a uses a random number r_{d(i)jk} in order to create the third link key creation information R_{d(i)jk}, and uses a message authentication code (MAC) having F_{D(i)jD(i)k} as its key, in order to create the third authentication information M_{d(i)jk}.

According to an embodiment of the present invention, F_{D(i)jD(i)k} is as in Formula 10 below.

F_{D}_{₍ᵢ₎ⱼ}_{D}_{₍ᵢ₎ₖ}=e(S₍ᵢ₎ⱼ, Q₍ᵢ₎ₖ)=e(Q₍ᵢ₎ⱼ, Q₍ᵢ₎ₖ)^{s}^{ᵢ} [Formula 10]

In other words, the first communication device 412a uses its second secret key S₍ᵢ₎ⱼ and the public key Q₍ᵢ₎ₖ of the second communication device 412b to express the key F_{D(i)jD(i)k} used in the third authentication information M_{d(i)jk} as a pairing function.

With reference to the third authentication information M_{d(i)jk} above, the third authentication information M_{d(i)jk} can use time information t in order to prevent replay attacks.

Subsequently, the second communication device 412b creates a fourth link key creation information R_{d(i)kj} and a fourth authentication information M_{d(i)kj} as in Formula 11 below (operation S702).

$${R}_{d ( i ) kj} = {r}_{d ( i ) kj} P \\ {M}_{d ( i ) kj} = {MAC}_{{F}_{{D}_{( i ) j} {D}_{( i ) k}}} ( {D}_{( i ) j} , {D}_{( i ) k} , {R}_{{d}_{( i ) kj}} , t ) \qquad [ Formula 11 ]$$

Here, r_{d(i)kj} is a random number (integer) selected from a particular group Zₚ*, that is to say, r_{d(i)kj}∈Zₚ*, and t is time information.

With reference to Formula 11 above, the second communication device 412b uses a random number r_{d(i)kj} in order to create the fourth link key creation information R_{d(i)kj}, and uses a message authentication code (MAC) having F_{D(i)jD(i)k} as its key, in order to create the fourth authentication information M_{d(i)kj}.

According to an embodiment of the present invention, F_{D(i)jD(i)k} is as in Formula 12 below.

F_{D}_{₍ᵢ₎ⱼ}_{D}_{₍ᵢ₎ₖ}=e(Q₍ᵢ₎ⱼ, S₍ᵢ₎ₖ)=e(Q₍ᵢ₎ⱼ, Q₍ᵢ₎ₖ)^{s}^{ᵢ} [Formula 12]

In other words, the second communication device 412b uses the public key Q₍ᵢ₎ⱼ of the first communication device 412b and its own second secret key S₍ᵢ₎ₖ to express the key F_{D(i)jD(i)k}, used in the fourth authentication information M_{d(i)kj}, as a pairing function.

With reference to the fourth authentication information M_{d(i)kj} above, the fourth authentication information M_{d(i)kj} can use time information t for preventing replay attacks.

Subsequently, the first communication device 412a transmits the third link key creation information R_{d(i)jk} and the third authentication information M_{d(i)jk} to the second communication device 412b (operation S704).

Next, the second communication device 412b transmits the fourth link key creation information R_{d(i)kj} and the fourth authentication information M_{d(i)kj} to the first communication device 412a (operation S706).

Subsequently, the first communication device 412a uses the fourth authentication information M_{d(i)kj} transmitted above, to authenticate the second communication device 412b (operation S708). In more detail, the first communication device 412a uses the key F_{D(i)jD(i)k} of the message authentication code (MAC) to interpret the fourth authentication information M_{d(i)kj}, verifying whether or not the node that transmitted the fourth authentication information M_{d(i)}ₖⱼ is the second communication device 412b. For example, the first communication device 412a may authenticate the second communication device 412b as a valid node if the resultant value of the message authentication code (MAC) using F_{D(i)jD(i)k} as its key with inputs D₍ᵢ₎ⱼ, D₍ᵢ₎ₖ, R_{d(i)kj}, and t is equal to the value of M_{d(i)kj} in Formula 11.

Subsequently, the second communication device 412b uses the third authentication information M_{d(i)jk}transmitted above, to authenticate the first communication device 412a. In more detail, the second communication device 412b uses a pairing function to interpret the key F_{D(i)jD(i)k} of the message authentication code (MAC), verifying whether or not the node that transmitted the third authentication information M_{d(i)jk} is the first communication device 412a. For example, the second communication device 412b may authenticate the first communication device 412a as a valid node if the resultant value of the message authentication code (MAC) using F_{D(i)jD(i)k} as its key with inputs D₍ᵢ₎ⱼ, D₍ᵢ₎ₖ, R_{d(i)jk}, and t is equal to the value of M_{d(i)jk} in Formula 9.

Subsequently, the first communication device 412a, after mutual authentication is completed, uses the fourth link key creation information R_{d(i)kj} transmitted above, to create the link key LK_{D(i)jD(i)k} as in Formula 13 below (operation S712).

LK_{D}_{₍ᵢ₎ⱼ}_{D}_{₍ᵢ₎ₖ}=H₂(r_{d}_{₍ᵢ₎ⱼₖ} R_{d}_{₍ᵢ₎ₖⱼ})=H₂(r_{d}_{₍ᵢ₎ⱼₖ} r_{d}_{₍ᵢ₎ₖⱼ} P) [Formula 13]

In other words, the first communication device 412a expresses its random number r_{d(i)jk} and the fourth link key creation information R_{d(i)kj} as a hash function, creating the link key LK_{D(i)jD(i)k}.

Subsequently, the second communication device 412b, after mutual authentication is completed, uses the third link key creation information R_{d(i)jk} transmitted above, to create the link key LK_{D(i)jD(i)k} as in Formula 14 below (operation S714).

LK_{D}_{₍ᵢ₎ⱼ}_{D}_{₍ᵢ₎ₖ}=H₂(r_{d}_{₍ᵢ₎ₖⱼ} R_{d}_{₍ᵢ₎ⱼₖ})=H₂(r_{d}_{₍ᵢ₎ⱼₖ} r_{d}_{₍ᵢ₎ₖⱼ} P) [Formula 14]

In other words, the second communication device 412b expresses its random number r_{d(i)kj} and the third link key creation information R_{d(i)jk} as a hash function, creating the link key LK_{D(i)jD(i)k}.

Consequently, the first communication device 412a and the second communication device 412b can create the same link key LK_{D(i)jD(i)k}, using the link key LK_{D(i)jD(i)k} thus created to communicate with each other.

In short, communication devices within the same cluster first authenticate each other for point-to-point communication, and if authentication is completed, create the link key.

Next, the communication process (authentication process and link key creation process) between coordinators of different clusters will be described.

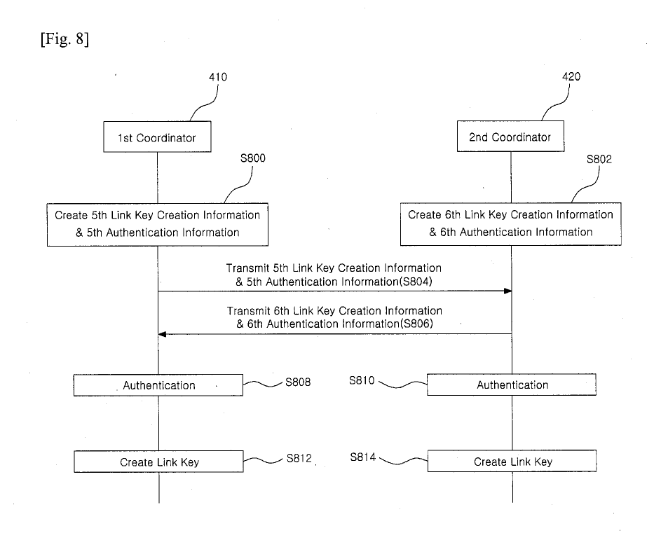

FIG. 8 is a flowchart illustrating the communication process between coordinators of different clusters according to an embodiment of the present invention. However, for the sake of ease of explanation, it is assumed that communication is made between the coordinator 410, Cᵢ, of the “i”th cluster 400 and the coordinator 420, Cₗ, of the “l(1 [symbol] ≠ [symbol] )”th cluster 402 in FIG. 4.

With reference to FIG. 8, the first coordinator 410 creates a fifth link key creation information R_{c(i)(l)} and a fifth authentication information M_{c(i)(l)} as in Formula 15 below (operation S800).

$${R}_{{c}_{( i ) l}} = {r}_{{c}_{( i ) l}} P \\ {M}_{c ( i ) ( l )} = {MAC}_{{F}_{{C}_{i} {C}_{l}}} ( {C}_{i} , {C}_{l} , {R}_{{c}_{( i ) ( l )}} , t ) \qquad [ Formula 15 ]$$

Here, r_{c(i)(l)} is a random number (integer) selected from a particular group Zₚ*, that is to say, r_{c(i)(l)}∈Zₚ*, and t is time information.

With reference to Formula 15 above, the first coordinator 410 uses a random number r_{c(i)(l)} in order to create the fifth link key creation information R_{c(i)(l)}, and uses a message authentication code (MAC) having F_{C(i)C(l)} as its key, in order to create the fifth authentication information M_{c(i)(l)}.

According to an embodiment of the present invention, F_{C(i)C(l)} is as in Formula 16 below.

F_{C}_{ᵢ}_{C}_{ₗ}=sᵢ P_{publ}=sᵢsₗP

In other words, the first coordinator 410 uses its secret key sᵢ and the public key P_{publ} of the second coordinator 420 to create the fifth authentication information M_{c(i)(l)}.

With reference to the fifth authentication information M_{c(i)(l)} above, the fifth authentication information M_{c(i)(l)} can use time information t in order to prevent replay attacks.

Subsequently, the second coordinator 420 creates a sixth link key creation information R_{c(l)(i)} and a sixth authentication information M_{c(l)(i)} as in Formula 17 below (operation S802).

$${R}_{{c}_{( l ) i}} = {r}_{{c}_{( l ) i}} P \\ {M}_{c ( l ) ( i )} = {MAC}_{{F}_{{C}_{i} {C}_{l}}} ( {C}_{i} , {C}_{l} , {R}_{{c}_{( l ) ( i )}} , t ) \qquad [ Formula 17 ]$$

Here, r_{c(l)(i)} is a random number (integer) selected from a particular group Zₚ*, that is to say, r_{c(l)(i)}∈Zₚ*, and t is time information.

With reference to Formula 17 above, the second coordinator 420 uses a random number r_{c(l)(i)} in order to create the sixth link key creation information R_{c(l)(i)}, and uses a message authentication code (MAC) having F_{C(i)C(l)} as its key, in order to create the sixth authentication information M_{c(l)(i)}.

According to an embodiment of the present invention, F_{C(i)C(l)} is as in Formula 18 below.

F_{C}_{ᵢ}_{C}_{ₗ}=sₗP_{pubi}=sᵢsₗP [Formula 18]

In other words, the second coordinator 420 uses its secret key Sₗ and the public key P_{pubi} of the first coordinator 410 to create the sixth authentication information M_{c(l)(i)}.

With reference to the sixth authentication information M_{c(l)(i)} above, the sixth authentication information M_{c(l)(i)} can use time information t for preventing replay attacks.

Subsequently, the first coordinator 410 transmits the fifth link key creation information R_{c(i)(l)} and the fifth authentication information M_{c(i)(l)} to the second coordinator 420 (operation S804).

Next, the second coordinator 420 transmits the sixth link key creation information R_{c(l)(i)} and the sixth authentication information M_{c(l)(i)} to the first coordinator 410 (operation S806).

Subsequently, the first coordinator 410 uses the sixth authentication information M_{c(l)(i)} transmitted above to authenticate the second coordinator (operation S808). In more detail, the first coordinator 410 interprets the sixth authentication information M_{c(l)(i)} to verify whether or not the node that transmitted the sixth authentication information M_{c(l)(i)} is the second coordinator 420. For example, the first coordinator 410 may authenticate the second coordinator 420 as a valid node if the resultant value of the message authentication code (MAC) using F_{C(i)C(l)} as its key with inputs Cᵢ, Cₗ, R_{c(l)i}, and t is equal to the value of M_{c(l)(i)} in Formula 17.

Subsequently, the second coordinator 420 uses the fifth authentication information M_{c(i)(l)} transmitted above to authenticate the first coordinator 410. In more detail, the second coordinator 420 interprets the fifth authentication information M_{c(i)(l)} to verify whether or not the node that transmitted the fifth authentication information M_{c(i)(l)} is the first coordinator 410. For example, the second coordinator 420 may authenticate the first coordinator 410 as a valid node if the resultant value of the message authentication code (MAC) using F_{C(i)C(l)} as its key with inputs Cᵢ, Cₗ, R_{c(i)l}, and t is equal to the value of M_{c(i)(l)} in Formula 15.

In other words, point-to-point communication nodes perform mutual authentication processes, one authenticating the other as a valid node if the value of the authentication information transmitted from the other is equal to the resultant value of the message authentication code (MAC) that one created for the information transmitted from the other.

Subsequently, the first coordinator 410, after mutual authentication is completed, uses the sixth link key creation information R_{c(l)(i)} transmitted above to create the link key LK_{CiCl} as in Formula 19 below (operation S812).

LK_{C}_{ᵢ}_{C}_{ₗ}=H₂(r_{c}_{₍ᵢ₎₍ₗ₎} R_{c}_{₍ₗ₎₍ᵢ₎})=H₂(r_{c}_{₍ᵢ₎₍ₗ₎} r_{c}_{₍ₗ₎₍ᵢ₎} P) [Formula 19]

In other words, the first coordinator 410 expresses its random number r_{c(i)l} and the sixth link key creation information R_{c(l)(i)} as a hash function, creating the link key LK_{CiCl}.

Subsequently, the second coordinator 420, after mutual authentication is completed, uses the fifth link key creation information R_{c(i)(l)} transmitted above to create the link key LK_{CiCl} as in Formula 20 (operation S814).

LK_{C}_{ᵢ}_{C}_{ₗ}=H₂(r_{c}_{₍ₗ₎₍ᵢ₎} R_{c}_{₍ᵢ₎₍ₗ₎})=H₂(r_{c}_{₍ᵢ₎₍ₗ₎} r_{c}_{₍ₗ₎₍ᵢ₎} P) [Formula 20]

In other words, the second coordinator 420 expresses its random number r_{c(l)(i)} and the fifth link key creation information R_{c(i)(l)} as a hash function, creating the link key LK_{CiCl}.

Consequently, the first coordinator 410 and the second coordinator 420 can create the same link key LK_{CiCl}, and use the link key LK_{CiCl} created above to authenticate each other.

In short, coordinators of different clusters first authenticate each other for point-to-point communication, and if authentication is completed, create the link keys.

Next, the communication process (authentication process and link key creation process) between a coordinator of a first cluster and a communication device of a second cluster will be described.

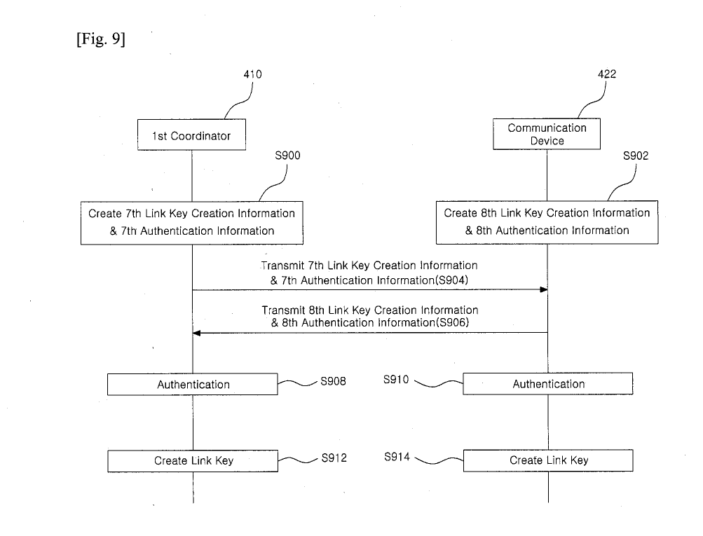

FIG. 9 is a flowchart illustrating the communication process between a coordinator of a first cluster and a communication device of a second cluster. However, for the sake of ease of explanation, it is assumed that communication is made between the coordinator 410, Cᵢ, of the “i”th cluster 400 and the “j”th communication device 422, D₍ₗ₎ⱼ out of the communication devices in the first cluster 402 in FIG. 4.

With reference to FIG. 9, the coordinator 410 creates a seventh link key creation information R_{c(i)(l)j} and a seventh authentication information M_{c(i)(l)j} as in Formula 21 below (operation S900).

$${R}_{{c}_{( i ) ( l ) j}} = {r}_{{c}_{( i ) ( l ) j}} P \\ {M}_{c ( i ) ( l ) j} = {MAC}_{{F}_{{C}_{i} {D}_{( l ) j}}} ( {C}_{i} , {D}_{( l ) j} , {R}_{{c}_{( i ) ( l ) j}} , t ) \qquad [ Formula 21 ]$$

Here, r_{c(i)(l)j} is a random number (integer) selected from a particular group Zₚ*, that is to say, r_{c(i)(l)j}∈Zₚ*, and t is time information.

With reference to Formula 21 above, the coordinator 410 uses a random number r_{c(i)(l)j} in order to create the seventh link key creation information R_{c(i)(l)j}, and uses a message authentication code (MAC) having F_{CiD(l)j} as its key, in order to create the seventh authentication information M_{c(i)(l)j}.

According to an embodiment of the present invention, F_{CiD(l)j} is as in Formula 22 below.

F_{C}_{ᵢ}_{D}_{₍ₗ₎ⱼ}=e(P_{pubi}, Q₍ₗ₎ⱼ)^{s}^{ᵢ}=e(P, Q₍ₗ₎ⱼ)^{s}^{ᵢ}^{s}^{ₗ} [Formula 22]

In other words, the coordinator 410 uses its public key P_{pubi} and the secret key S₍ₗ₎ⱼ of the communication device 422 to express the key F_{CiD(l)j} used in the seventh authentication information M_{c(i)(l)j} as a pairing function.

With reference to the seventh authentication information M_{c(i)(l)j} above, the seventh authentication information M_{c(i)(l)j} can use time information in order to prevent replay attacks.

Subsequently, the communication device 422 creates an eighth link key creation information R_{d(i)j(i)} and an eighth authentication information M_{d(l)j(i)} as in Formula 23 below (operation S902).

$${R}_{{d}_{( l ) j ( i )}} = {r}_{{d}_{( l ) j ( i )}} P \\ {M}_{d ( l ) j ( i )} = {MAC}_{{F}_{{C}_{i} {D}_{( l ) j}}} ( {C}_{i} , {D}_{( l ) j} , {R}_{{d}_{( l ) j ( i )}} , t ) \qquad [ Formula 23 ]$$

Here, r_{d(l)j(i)} is a random number (integer) selected from a particular group Zₚ*, that is to say, r_{d(l)j(i)}∈Zₚ*, and t is time information.

With reference to Formula 23 above, the communication device 422 uses a random number r_{d(l)j(i)} in order to create the eighth link key creation information R_{d(l)j(i)}, and uses a message authentication code (MAC) having F_{CiD(l)j} as its key, in order to create the eighth authentication information M_{d(l)j(i)}.

According to an embodiment of the present invention, F_{CiD(l)j} is as in Formula 24 below.

F_{C}_{ᵢ}_{D}₍ₗ₎ⱼ=e(P_{pubi}, S₍ₗ₎ⱼ)=e(P, Q₍ₗ₎ⱼ)^{s}^{ᵢ}^{s}^{ₗ} [Formula 24]

In other words, the communication device 422 uses the public key of the coordinator 410 and its own secret key S₍ₗ₎ⱼ to express the key F_{CiD(l)j} used in the eighth authentication information M_{d(l)j(i)} as a pairing function.

With reference to the eighth authentication information M_{d(l)j(i)} above, the eighth authentication information M_{d(l)j(i)} can use time information t, for preventing replay attacks.

Subsequently, the coordinator 410 transmits the seventh link key creation information R_{c(i)(l)j} and the seventh authentication information M_{c(i)(l)j} to the communication device 422 (operation S904).

Next, the communication device 422 transmits the eighth link key creation information R_{d(l)j(i)} and the eighth authentication information M_{d(l)j(i)} to the coordinator 410 (operation S906).

Subsequently, the coordinator 410 uses the eighth authentication information M_{d(l)j(i)} transmitted above to authenticate the communication device 422 (operation S908). In more detail, the coordinator 410 uses the key F_{CiD(l)j} of the message authentication code (MAC) to interpret the eighth authentication information M_{d(l)j(i)}, verifying whether or not the node that transmitted the eighth authentication information F_{CiD(l)j} is the communication device 422. For example, the coordinator 410 may authenticate the communication device 422 as a valid node if the resultant value of the message authentication information (MAC) using the key F_{CiD(l)j} with inputs Cᵢ, D₍ₗ₎ⱼ, R_{d(l)j(i)}, and t is equal to the value of M_{d(l)j(i)} in Formula 23.

Next, the communication device 422 uses the seventh authentication information M_{c(i)(l)j} transmitted above to authenticate the coordinator 410 (operation S910). In more detail, the communication device 422 uses the key F_{CiD(l)j} of the message authentication code (MAC) to interpret the seventh authentication information M_{c(i)(l)j}, verifying whether or not the node that transmitted the seventh authentication information M_{c(i)(l)j} is the coordinator 410. For example, the communication device 422 may authenticate the coordinator 410 as a valid node if the resultant value of the message authentication code (MAC) using the key F_{CiD(l)j} with inputs Cᵢ, D₍ₗ₎ⱼ, R_{C(i)(l)j}, and t is equal to the value of M_{c(i)(l)j} in Formula 21.

In other words, point-to-point communication nodes perform a mutual authentication process, one authenticating the other as a valid node if the value of the authentication information transmitted from the other is equal to the resultant value of the message authentication code (MAC) that one created for the information transmitted from the other.

Subsequently, the coordinator 410, after mutual authentication is completed, uses the eighth link key creation information R_{d(l)j(i)} transmitted above to create the link key LK_{CiD(l)j} as in Formula 25 below (operation S912).

LK_{C}_{ᵢ}_{D}_{₍ₗ₎ⱼ}=H₂(r_{c}_{₍ᵢ₎₍ₗ₎ⱼ} R_{d}_{₍ₗ₎ⱼ₍ᵢ₎})=H₂(r_{c}_{₍ᵢ₎₍ₗ₎ⱼ} r_{d}_{₍ₗ₎ⱼ₍ᵢ₎} P) [Formula 25]

In other words, the coordinator 410 expresses its random number r_{c(i)(l)j} and the eighth link key creation information R_{d(l)j(i)} as a hash function, creating the link key LK_{CiD(l)j}.

Next, the communication device 422, after mutual authentication is completed, uses the seventh link key creation information R_{c(i)(l)j} transmitted above to create the link key LK_{CiD(l)j} as in Formula 26 below (operation S914).

LK_{C}_{ᵢ}_{D}_{₍ₗ₎ⱼ}=H₂(r_{d}_{₍ₗ₎ⱼ₍ᵢ₎} R_{c}_{₍ᵢ₎₍ₗ₎ⱼ})=H₂(r_{c}_{₍ᵢ₎₍ₗ₎ⱼ} r_{d}_{₍ₗ₎ⱼ₍ᵢ₎} P) [Formula 26]

In other words, the communication device 422 expresses its random number r_{d(l)j(i)} and the seventh link key creation information R_{c(i)(l)j} as a hash function, creating the link key LK_{CiD(l)j}.

Consequently, the coordinator 410 and the communication 422 can create the same link key LK_{CiD(l)j}, and use the link key LK_{CiD(l)j} thus created to communicate with each other.

In short, a coordinator and a communication device of different clusters first authenticate each other for point-to-point communication, and if the authentication is completed, create the link key.

Below, the communication process between communication devices of different clusters will be described.

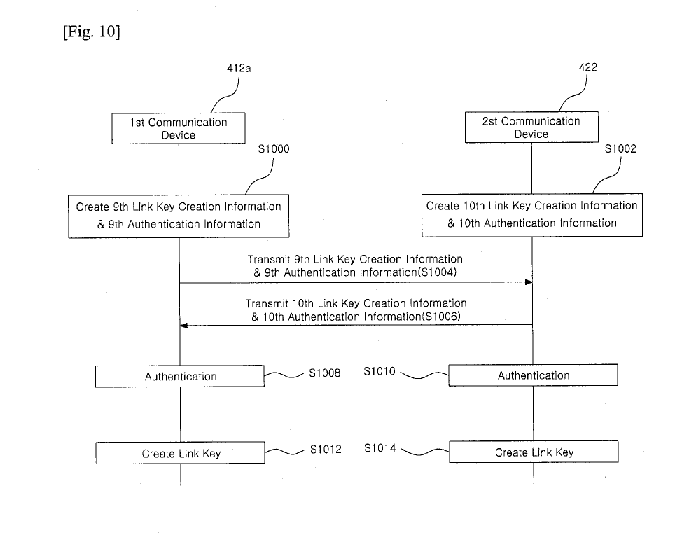

FIG. 10 is a flowchart illustrating the communication process between communication devices of different clusters according to an embodiment of the present invention. However, for the sake of ease of explanation, it is assumed that communication is made between the “j”th communication device 412a, D₍ᵢ₎ⱼ, out of the communication devices in the first cluster 400 and the “k”th communication device 422, D₍ₗ₎ₖ, out of the communication devices in the second cluster 402 in FIG. 4.

With reference to FIG. 10, the first communication device 412a creates a ninth link key creation information R_{d(i)j()k} and a ninth authentication information M_{d(i)j(l)k} as in Formula 27 (operation S1000).

R_{d}_{₍ᵢ₎ⱼ₍ₗ₎ₖ}=r_{d}_{₍ᵢ₎ⱼ₍ₗ₎ₖ} P

M_{d(i)j(l)k}=H₂(R_{d}_{₍ᵢ₎ⱼ₍ₗ₎ₖ},t) S₍ᵢ₎ⱼ+r_{d}_{₍ᵢ₎ⱼ₍ₗ₎ₖ} Q₍ₗ₎ₖ [Formula 27]

Here, r_{d(i)j(l)k} is a random number (integer) from a particular group Zₚ*, that is to say, r_{d(i)j(l)k}∈Zₚ*, and t is time information.

With reference to Formula 27, the first communication device 412a uses a random number r_{d(i)j(l)k} in order to create the ninth link key creation information R_{d(i)j(l)k}, and uses its own secret key S₍ᵢ₎ⱼ and the public key Q₍ₗ₎ₖ of the counterpart node in order to create the ninth authentication information M_{d(i)j(l)k}.

Next, the second communication device 422 creates a tenth link key creation information R_{d(l)k(i)j} and a tenth authentication information M_{d(l)k(i)j} as in Formula 28 below (operation S1002).

R_{d}_{₍ₗ₎ₖ₍ᵢ₎ⱼ}=r_{d}_{₍ₗ₎ₖ₍ᵢ₎ⱼ} P

M_{d(l)k(i)j}=H₂(R_{d}_{₍ₗ₎ₖ₍ᵢ₎ⱼ},t) S₍ₗ₎ₖ+r_{d}_{₍ₗ₎ₖ₍ᵢ₎ⱼ} Q₍ᵢ₎ⱼ [Formula 28]

Here, r_{d(l)k(i)j} is a random number (integer) selected from a particular group Zₚ*, that is to say, r_{d(l)k(i)j}∈Zₚ*, and t is time information.

With reference to Formula 28 above, the second communication device 422 uses a random number r_{d(l)k(i)j} in order to create the tenth link key creation information R_{d(l)k(i)j}, and uses its own secret key S₍ₗ₎ₖ and the public key Q₍ᵢ₎ⱼ of the counterpart node in order to create the tenth authentication information M_{d(l)k(i)j}.

Subsequently, the first communication device 412a transmits the ninth link key creation information R_{d(i)j(l)k} and the ninth authentication information M_{d(i)j(l)k} to the second communication device 422 (operation S1004).

Next, the second communication device 422 transmits the tenth link key creation information R_{d(l)k(i)j} and the tenth authentication information M_{d(l)k(i)j} to the first communication device 412a (operation S1006).

Subsequently, the first communication device 412a authenticates the second communication device 422 by verifying whether or not the equation in Formula 29 below holds (operation S1008).

e(M_{d}_{₍ₗ₎ₖ₍ᵢ₎ⱼ}, P)=e(Q₍ₗ₎ₖ, H₂(R_{d}_{₍ₗ₎ₖ₍ᵢ₎ⱼ},t)P_{publ}+R_{d}_{₍ₗ₎ₖ₍ᵢ₎ⱼ}) [Formula 29]

In more detail, the first communication device 412a authenticates the second communication device 422 as a valid node if the equation holds with the tenth link key creation information R_{d(l)k(i)j} and the tenth authentication information M_{d(l)k(i)j} substituted in Formula 29 above.

Next, the second communication device 422 authenticates the first communication device 412a by verifying whether or not the equation in Formula 30 below holds (operation S1010).

e(M_{d}_{₍ᵢ₎ⱼ₍ₗ₎ₖ}, P)=e(Q₍ᵢ₎ⱼ, H₂(R_{d}_{₍ᵢ₎ⱼ₍ₗ₎ₖ},t) P_{pubi}+R_{d}_{₍ᵢ₎ⱼ₍ₗ₎ₖ}) [Formula 30]

In more detail, the second communication device 422 authenticates the first communication device 412a as a valid node if the equation holds with the ninth link key creation information R_{d(i)j(l)k} and the ninth authentication information M_{d(i)j(l)k} substituted in Formula 30 above.

Subsequently, the first communication device 412a, after mutual authentication is completed, uses the tenth link key creation information R_{d((l)k(i)j} transmitted above, to create the link key LK_{D(i)jD(l)k} as in Formula 31 below (operation S1012).

LK_{D}_{₍ᵢ₎ⱼ}_{D}_{₍ₗ₎ₖ}=H₂(r_{d}_{₍ᵢ₎ⱼ₍ₗ₎ₖ} R_{d}_{₍ₗ₎ₖ₍ᵢ₎ⱼ})=H₂(r_{d}_{₍ᵢ₎ⱼ₍ₗ₎ₖ} r_{d}_{₍ₗ₎ₖ₍ᵢ₎ⱼ} P) [Formula 31]

In other words, the first communication device 412a expresses its random number r_{d(i)j(l)k} and the tenth link key creation information R_{d(l)k(i)j} as a hash function, creating the link key LK_{D(i)jD(l)k}.

Next, the second communication device 422, after mutual authentication is completed, uses the ninth link key creation information R_{d(i)j(l)k} transmitted above, to create the link key LK_{D(i)jD(l)k} as in Formula 32 below (operation S1014).

LK_{D}_{₍ᵢ₎ⱼ}_{D}_{₍ₗ₎ₖ}=H₂(r_{d}_{₍ₗ₎ₖ₍ᵢ₎ⱼ} R_{d}_{₍ᵢ₎ⱼ₍ₗ₎ₖ})=H₂(r_{d}_{₍ᵢ₎ⱼ₍ₗ₎ₖ} r_{d}_{₍ₗ₎ₖ₍ᵢ₎ⱼ} P) [Formula 32]

In other words, the second communication device 422 expresses its random number r_{d(l)k(i)j} and the ninth link key creation information R_{d(i)j(l)k} as a hash function, creating the link key LK_{D(i)jD(l)k}.

Consequently, the first communication device 412a and the second communication device 422 can create the same link key LK_{D(i)jD(l)k}, and use the link key LK_{D(i)jD(l)k} thus created to communicate with each other.

In short, communication devices of different clusters first authenticate each other for point-to-point communication, and if authentication is completed, create the link key.

Above, the authentication process and the link key creation process for each category of point-to-point communication were described.

Below, a point-to-point communication method according to an embodiment of the present invention will be compared with a point-to-point communication method according to the related art.

The point-to-point communication method according to the related art could only be applied to a single cluster with a small number of nodes, whereas the point-to-point communication method according to an embodiment of the present invention can be applied to multiple clusters with large numbers of nodes and is thus applicable to a realistic network.

Also, the point-to-point communication method according to the related art used a master key, which could be exposed, whereas the point-to-point communication method according to an embodiment of the present invention does not use a master key, but rather, uses authentication, information and link key creation information, thus being able to maintain security in a stable manner.

In addition, in the point-to-point communication method according to the related art, a coordinator managed the secret keys for communication devices belonging to it, whereas in the point-to-point communication method according to an embodiment of the present invention, it is sufficient for each coordinator just to manage its own secret key, thus simplifying the key management.

Furthermore, in the point-to-point communication method according to the related art, authentication between nodes was driven always with the involvement of the corresponding coordinator, thus concentrating the load on the coordinator, whereas in the point-to-point communication method according to an embodiment of the present invention, authentication between communication devices does not involve the coordinator, thus avoiding concentration of load on the coordinator. Thus, the problem of network load can be resolved, and the performance (efficiency) of the network can be enhanced.

Also, in the point-to-point communication method according to an embodiment of the present invention, since link key creation information is created with time information included, replay attacks can be prevented.

Thus, the point-to-point communication method in a wireless sensor network according to an embodiment the present invention can have various applications for commercial purposes and military purposes, which require a high degree of security, having various economic and commercial effects.

### INDUSTRIAL APPLICABILITY

The aforementioned embodiments of the present invention are for illustrative purposes only and do not limit the invention, and it is to be appreciated that various changes, modifications and additions may be made by those skilled in the art without departing from the spirit and scope of the present invention, as defined by the appended claims and their equivalents.

1. A point-to-point communication method in a wireless sensor network having plural nodes, the method comprising:
authentication by exchanging authentication information between a first node and a second node from among the plural nodes; and
having each of the first node and the second node create a link key, after the authentication is completed,
wherein the authentication information uses a secret key of a corresponding coordinator (node) during the authentication.

2. The point-to-point communication method in a wireless sensor network according to claim 1, the method further comprising:
an initialization operation of having each coordinator (node) create secret keys for communication devices (nodes) belonging to the same cluster.

3. The point-to-point communication method in a wireless sensor network according to claim 2, wherein the initialization operation comprises:
having each coordinator create a public key by using its secret key; and
creating secret keys for communication devices belonging to the same cluster by using the secret key of the coordinator.

4. The point-to-point communication method in a wireless sensor network according to claim 1, wherein the first node is a coordinator within a first cluster, and the second node is a communication device within the first cluster,
and wherein the authentication comprises:
having the coordinator create a first authentication information by using its secret key and a public key of the communication device;
having the coordinator transmit the first authentication information to the communication device;
having the communication device create a second authentication information by using its secret key and a public key of the coordinator;
having the communication device transmit the second authentication information to the coordinator;
having the coordinator authenticate the communication device through the transmitted first authentication information; and
having the communication device authenticate the coordinator through the transmitted second authentication information,
wherein each of the authentication information is expressed as a message authentication code (MAC) and uses a pairing function.

5. The point-to-point communication method in a wireless sensor network according to claim 4, the method further comprising:
having the coordinator create a first link key creation information;
having the communication device create a second link key creation information;
having the coordinator transmit the first link key creation information to the communication device; and
having the communication device transmit the second link key creation information to the coordinator,
wherein having each of the first node and the second node create a link key comprises:
having the coordinator create a first link key by using the transmitted second link key creation information, after the authentication is completed; and
having the communication device create a second link key by using the transmitted first link key creation information, after the authentication is completed,
and wherein each of the link keys is expressed as a hash function.

6. The point-to-point communication method in a wireless sensor network according to claim 1, wherein the first node is a first communication device within a first cluster, and the second node is a second communication device within the first cluster,
the authentication comprising:
having the first communication device create a first authentication information by using its secret key and a public key of the second communication device;
having the first communication device transmit the first authentication information to the second communication device;
having the second communication device create a second authentication information by using its secret key and a public key of the first communication device;
having the second communication device transmit the second authentication information to the first communication device;
having the first communication device authenticate the second communication device through the transmitted first authentication information; and
having the second communication device authenticate the first communication device through the transmitted second authentication information,
and wherein each of the authentication information is expressed in message authentication code (MAC) and uses a pairing function.

7. The point-to-point communication method in a wireless sensor network according to claim 6, the method further comprising:
having the first communication device create a first link key creation information;
having the second communication device create a second link key creation information;
having the first communication device transmit the first link key creation information to the second communication device; and
having the second communication device transmit the second link key creation information to the first communication device,
wherein having each of the first node and the second node create a link key comprises:
having the first communication device create a first link key by using the transmitted second link key creation information, after the authentication is completed; and
having the second communication device create a second link key by using the transmitted first link key creation information, after the authentication is completed,
and wherein each of the link keys is expressed as a hash function.

8. The point-to-point communication method in a wireless sensor network according to claim 1, wherein the first node is a first coordinator within a first cluster, and the second node is a second coordinator within the first cluster,
the authentication comprising:
having the first coordinator create a first authentication information by using its secret key and a public key of the second coordinator;
having the first coordinator transmit the first authentication information to the second coordinator;
having the second coordinator create a second authentication information by using its secret key and a public key of the first coordinator;
having the second coordinator transmit the second authentication information to the first coordinator;
having the first coordinator authenticate the second coordinator through the transmitted first authentication information; and
having the second coordinator authenticate the first coordinator through the transmitted second authentication information,
and wherein each of the authentication information is expressed as a message authentication code (MAC) and uses a pairing function.

9. The point-to-point communication method in a wireless sensor network according to claim 8, the method further comprising:
having the first coordinator create a first link key creation information;
having the second coordinator create a second link key creation information;
having the first coordinator transmit the first link key creation information to the second coordinator; and
having the second coordinator transmit the second link key creation information to the first coordinator,
wherein having each of the first node and the second node create a link key comprises:
having the first coordinator create a first link key by using the transmitted second link key creation information, after the authentication is completed; and
having the second coordinator create a second link key by using the transmitted first link key creation information, after the authentication is completed,
and wherein each of the link keys is expressed as a hash function.

10. The point-to-point communication method in a wireless sensor network according to claim 1, wherein the first node is a coordinator within a first cluster, and the second node is a communication device within a second cluster,
and wherein the authentication comprises:
having the coordinator create a first authentication information by using its secret key and a public key of the communication device;
having the coordinator transmit the first authentication information to the communication device;
having the communication device create a second authentication information by using its secret key and a public key of the coordinator;
having the communication device transmit the second authentication information to the coordinator;
having the coordinator authenticate the communication device through the transmitted first authentication information; and
having the communication device authenticate the coordinator through the transmitted second authentication information,
wherein each of the authentication information is expressed as a message authentication code (MAC) and uses a pairing function.

11. The point-to-point communication method in a wireless sensor network according to claim 10, the method further comprising:
having the coordinator create a first link key creation information;
having the communication device create a second link key creation information;
having the coordinator transmit the first link key creation information to the communication device; and
having the communication device transmit the second link key creation information to the coordinator,
wherein having each of the first node and the second node create a link key comprises:
having the coordinator create a first link key by using the transmitted second link key creation information, after the authentication is completed; and
having the communication device create a second link key by using the transmitted first link key creation information, after the authentication is completed,
and wherein each of the link keys is expressed as a hash function.

12. The point-to-point communication method in a wireless sensor network according to claim 1, wherein the first node is a first communication device within a first cluster, and the second node is a second communication device within a second cluster,
the authentication comprising:
having the first communication device create a first authentication information by using its secret key and a public key of the second communication device;
having the first communication device transmit the first authentication information to the second communication device;
having the second communication device create a second authentication information by using its secret key and a public key of the first communication device;
having the second communication device transmit the second authentication information to the first communication device;
having the first communication device authenticate the second communication device through the transmitted first authentication information; and
having the second communication device authenticate the first communication device through the transmitted second authentication information,
and wherein each of the authentication information is expressed as a hash function, and the authentication is performed by determining whether or not a particular equation holds.

13. The point-to-point communication method in a wireless sensor network according to claim 12, the method further comprising:
having the first communication device create a first link key creation information;
having the second communication device create a second link key creation information;
having the first communication device transmit the first link key creation information to the second communication device; and
having the second communication device transmit the second link key creation information to the first communication device,
wherein having each of the first node and the second node create a link key comprises:
having the first communication device create a first link key by using the transmitted second link key creation information, after the authentication is completed; and
having the second communication device create a second link key by using the transmitted first link key creation information, after the authentication is completed,
and wherein each of the link keys is expressed as a hash function.

14. A method of driving a coordinator included in a wireless sensor network, the method comprising;
creating a first public key by using a first secret key of the coordinator; and
creating a second secret key for at least one communication device in the same cluster, by using the first secret key.

15. The method of driving a coordinator included in a wireless sensor network according to claim 14, wherein the second secret key for the communication device is formed by a combination of the first secret key and a second a public key, the second public key obtained from an identification information of the communication device.

16. The method of driving a coordinator included in a wireless sensor network according to claim 14, the method further comprising:
creating a first authentication information by using the first secret key and a second public key of the communication device;
authenticating the communication device through a second authentication information transmitted from the communication device;
creating a first link key creation information; and
creating a link key through a second link key creation information transmitted from the communication device.

17. The method of driving a coordinator included in a wireless sensor network according to claim 14, the method further comprising:
creating a first authentication information by using the first secret key and a public key of a second coordinator within another cluster;
authenticating the second coordinator through a second authentication information transmitted from the second coordinator;
creating a first link key creation information; and
creating a link key through a second link key creation information transmitted from the second coordinator,
wherein each of the authentication information is expressed as a message authentication code (MAC) and uses a pairing function, and the link key is expressed as a hash function.

18. A method of driving a first communication device included in a wireless sensor network, the method comprising:
authenticating a coordinator or a second communication device through a second authentication information transmitted from the coordinator or the second communication device; and
creating a link key by using a second link key creation information transmitted from the coordinator or the second communication device,
wherein the authentication information is expressed as a message authentication code (MAC) and uses a pairing function, and the link key is expressed as a hash function.

19. The method of driving a communication device in a wireless sensor network according to claim 18, the method further comprising:
creating a first authentication information by using a second secret key of the first communication device and a public key of the coordinator; and
creating a first link key creation information,
wherein the second secret key is formed by a combination of the first secret key and a public key, the public key obtained from an identification information of the first communication device.

20. The method of driving a communication device in a wireless sensor network according to claim 18, the method further comprising:
creating a first authentication information by using a second secret key of the first communication device and a public key of the second communication device; and
creating a first link key creation information,
wherein the second secret key is formed by a combination of the first secret key and a public key, the public key obtained from an identification information of the first communication device.

21. The method of driving a communication device in a wireless sensor network according to claim 20, wherein, if the second communication device exists in the same cluster as the first communication device, each of the authentication information is expressed as a message authentication code (MAC) and uses a pairing function,
and if the second communication device exists in a different cluster from the first communication device, each of the authentication information is expressed as a hash function and the authentication is performed by determining whether or not a particular equation holds.
